(19) United States
(12) Patent Application Publication
(10) Pub. No.: US 2012/0216183 A1
(43) Pub. Date: Aug. 23, 2012

(54) FIRMWARE UPDATION IN ELECTRONIC DEVICES

(76) Inventors: Amit Mahajan, Bangalore (IN); Venkatasubramanian Narayanan, Sahakara Nagar (IN)

(21) Appl. No.: 13/372,951

(22) Filed: Feb. 14, 2012

(30) Foreign Application Priority Data
Feb. 23, 2011 (IN) 538/CHE/2011

(51) Int. Cl. G06F 9/44

(52) U.S. Cl. 717/170; 717/172

(57) ABSTRACT

Described herein is a method for updating firmware in systems having a plurality of peer devices which are discrete replaceable units coupled to a control unit. In one embodiment, the method of updating firmware comprises receiving a firmware update in any one of the peer devices and determining of compatibility of the firmware update with a current firmware operating in the peer devices. Based on the determination, either the current firmware or firmware update may be revised such that, at any given point in time, the peer devices contain compatible firmware.

### CROSS-REFERENCE TO RELATED APPLICATIONS

This application claims benefit of Indian patent application serial number 538/CHE/2011, filed Feb. 23, 2011, which is herein incorporated by reference.

### TECHNICAL FIELD

The present subject matter relates, in general, to electronic devices and, particularly but not exclusively, to updating of firmware in the electronic devices.

### BACKGROUND

Electronic devices, such as communication devices, computing devices and display devices contain firmware. The firmware is basically a set of encoded instructions that reside in a memory component of a device and may be executed by a processor of the device to perform various operations of the device. The firmware in the devices may require modifications or updates from time to time. For example, a version of the firmware currently in a device may be updated to a latest version. Updates usually enhance functionality of the devices. For example, an update in a computing device, such as a laptop, may enhance a security feature of the laptop. In some cases, an update may also add a new functionality to a device. For instance, an update in a video player may enable the video player to play videos in a new format that was not supported prior to the update. In another example, an update may be required to make the device compatible with a new version of software or peripherals.

Updates may be varying in functionality. While some updates may only be desirable to impart greater capabilities to the devices, others may be critical to the basic operation of the device without which the device may be rendered non-functional. Further, an update in the firmware may not generally involve any change in the hardware of the device. The update to the firmware of the device, also referred to as firmware update, may be understood as one or more sets of encoded instructions that either replace or supplement the encoded instructions that are currently resident in the device.

Firmware updates, for example, are necessary either to allow the set of encoded instructions to act on a modified device in order to improve the functionality of one or more hardware components of the device or to modify the functionality of the device. For example, an update in the firmware may be necessitated because of a change in the interface hardware.

As technology continues to evolve, updated firmware come about very recurrently. Manufacturers of such electronic devices find it imperative to update these devices with the revised firmware to maintain the latest version of the firmware in all the devices and to enable a number of new features and functions.

### SUMMARY

The subject matter described herein is directed towards methods and systems for updating firmware of electronic devices. This summary is not intended to identify essential features of the claimed subject matter, nor is it intended for use in determining the scope of the claimed subject matter.

The subject matter described herein is directed towards a method of updating firmware in a plurality of devices wherein each device is a peer to another device. The method comprises receiving a firmware update in a restored device from amongst the plurality of devices and updating all peer devices with the firmware update based on a determination of compatibility of the firmware update with a firmware operating on the plurality of devices. In one embodiment, the firmware update may be modified in accordance with the firmware operating on the plurality of devices.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

It should be appreciated by those skilled in the art that any block diagrams herein represent conceptual views of illustrative systems embodying the principles of the present subject matter. Similarly, it will be appreciated that various alternate embodiments and/or implementation, whether or not explicitly shown, will be apparent to one skilled in the art. Some embodiments of system and/or methods of the present subject matter are now described, by way of example only, and with reference to the accompanying drawings, in which:

FIG. 1 illustrates an exemplary display system comprising a plurality of peer devices, in accordance with an embodiment of the present subject matter;

FIG. 2 shows an exemplary display system comprising a plurality of control unit, according to another embodiment of the present subject matter;

FIG. 3 illustrates an exemplary control unit, according to an embodiment of the present subject matter; and

FIG. 4 illustrates an exemplary method of updating firmware in peer devices, in accordance with an embodiment of the present subject matter.

### DETAILED DESCRIPTION

The disclosed subject matter relates to updation of firmware in electronic devices. The methods and systems described herein automatically update firmware in the devices based on an update in one or more peer devices. The peer devices may be referred to as discrete replaceable units that may be communicatively coupled to each other and/or to a central controller in a system. In one embodiment, the peer devices may be identical or similar devices within the system, such that the devices are functionally interchangeable. Accordingly, in one embodiment of the invention, the peer devices may contain the same firmware to enable the peer devices to perform similar operations. It would be apparent that various modifications, adaptations, and alternative embodiments of the explained concepts may be made to extend the principle explained herein to other systems.

The described methods and systems may be implemented to carry out firmware updates in a variety of electronic devices. Examples of such electronic devices include, but are not limited to, display devices such as, laser phosphor displays (LPD) and light emitting diode (LED) based displays that may be used in conjunction with similar display devices in integrated display assemblies, for example, display systems. Such display systems, for instance, may include electronic billboard screens used for advertisement purposes or as large screen electronic displays typically put up in public places either for entertainment purposes or to provide information. It would be appreciated that though the description extends to any electronic device and system it is only for purposes of illustration and ease of understanding that the subject matter has been explained herein in context of a display system, such as a LPD system.

In accordance with one embodiment of the present subject matter, a display system may comprise a plurality of display devices arranged together to form a large screen display. In one implementation, the display system may be an LPD system. The LPD system may comprise a plurality of individual LPD devices, also referred to as LPD tiles, arranged together. The LPD devices within the LPD system can be controlled by a control unit. The LPD devices individually communicate with the control unit and also with each other through the control unit. The control unit includes firmware component, i.e., a controller firmware, to enable its desired operation within the LPD system. Likewise, each LPD device in the LPD system is configured to operate in a manner to perform similar functions and, therefore, each of the LPD devices comprise similar firmware components that may be referred to as tile firmware. Thus, as is evident, each of the LPD devices would be a peer to the other LPD devices in the LPD system.

In some implementations, where large displays are required, the number of LPD tiles may be large. In such a case, it is common to have more than one control unit associated with the LPD tiles. For example, in a LPD system having a large number of LPD tiles, two control units may be utilized such that half of the LPD tiles are controlled by one control unit and the remaining half by the other control unit.

Amongst others, a primary function of the control unit relates to providing display content in the form of either a still image or a video to the LPD devices. The control units may receive display content from various sources. In one example, the display content may be received from a video input device associated with the LPD system. In one example, the display content may be received from a remote source through a communication network. Each control unit performs the necessary decoding operation and makes the display content available to all the LPD devices coupled to it. The control units manage the individual LPD devices, where each individual LPD device displays a part of a large image, in such a manner that the image displayed by the LPD system appears coherent and integrated as one image. In cases where the LPD system includes a plurality of control units, the control units can communicate with each other and with each of the LPD devices that may be coupled to it. In the present implementation, it will be appreciated that the plurality of control units also perform similar functions in the LPD system and accordingly, can also be considered as peer to each other.

As mentioned previously, the tile firmware in the LPD devices and the controller firmware in the control units enable interoperation of the LPD devices and the control units, respectively, to allow desired operation of the LPD system. In such a system, at any given point in time, all the LPD devices and the control units within the LPD system include the same version of their respective firmware to ensure that the LPD systems function in an expected manner. For instance, in a situation where the various control units have dissimilar versions of the controller firmware, any communication/information received by the control units from an external source may be required to be in different formats in accordance with the different versions of the controller firmware. Similarly, in cases where the different LPD devices associated with a control unit run on dissimilar versions of the tile firmware, the control unit may not be enabled to control the LPD devices.

Such problems, caused by different versions of firmware in various components of the LPD system often hamper the operation of the LPD system. Accordingly, it is desired that the same version of the firmware be maintained in all the components. The term ‘firmware’ may include tile firmware as well as controller firmware. Same version of the firmware may comprise compatible versions of tile firmware and controller firmware.

Conventionally, an update operation in the LPD systems is generally performed by an operator of the LPD system. In one example, a firmware update may be made available to the operator by a remote server, say, through an e-mail which can be downloaded by the operator and can be subsequently stored onto a data storage device. The downloaded updated firmware can be used to update the LPD system, i.e., update the tile and/or the controller firmware either individually or collectively. In such a scenario, the operator may have to regularly monitor, obtain, and install the firmware updates to keep the LPD system up-to-date. The operator is required to take actions explicitly, such as downloading new updates periodically and configuring the updates on the LPD system based on sets of predefined instructions. Many of these tasks are time consuming and may be prone to human errors. In addition, tracking the version of the firmware currently present on the LPD system needs to be accurately done by the operator. It is often experienced that if the updates are not properly installed, the LPD system is left open to the risk of degraded performance.

Alternatively, the LPD system may be configured to automatically download the new updates, when made available, from a remote server connected to the LPD system through a communication network. Such configurations require significant IT resources. In addition, in such an approach, attempts to upgrade firmware are often constrained by slow download speeds. Further, downloading an update may be a lengthy and resource consuming process, inhibiting operational use of some functions of the LPD system while the download takes place. Accordingly, this approach is accomplished at the expense of the transmission time and network resources.

To this end, in accordance with one embodiment of the subject matter, disclosed herein are methods and systems that automatically update firmware in various peer devices of LPD systems. The updation is based on a firmware update that may be made available to any one of the peer devices in the LPD system. The term ‘firmware update’ may include a revised or updated version of a firmware and is interchangeably referred to as updated firmware, updated version of firmware or revised version of firmware hereinafter.

In one embodiment of the present subject matter, an update in a firmware of any one of the LPD tile is detected by the associated control unit. Further to the detection, the control unit initiates firmware updation in all peer LPD tiles. Similarly, in case the LPD system includes more than one control units, the updates are communicated to each of the control units to facilitate updating of LPD tiles coupled to the respective control units. If the detected update includes updates in tile firmware, only the LPD devices get updated. However, if the detected update includes controller firmware updates, either exclusively or along with the tile firmware updates, the control units also undergo an updation.

The revised version of the firmware may be made available to any one of LPD devices, for example, during the course of a repair operation. In another example, an LPD device may be replaced with a new LPD device having an updated version of the firmware. For instance, such a replacement may be generally carried out to substitute a new LPD device for a malfunctioning LPD device in the LPD system. The updated version of the firmware of the new LPD device is used to modify or replace the firmware pre-embedded in other LPD devices.

The described subject matter provides for effortlessly updating firmware in all the LPD devices or the control units of the LPD system. As would be appreciated by a person skilled in the art, the dependency on the operator for obtaining firmware updates is eliminated. Furthermore, systems and methods for updating firmware as described above, reduce network resource consumption and are not hampered when network is not available. The updation process is therefore, fast and does not consume undue resources of the LPD system. Additionally, tracking of the version of the firmware currently being executed by the LPD system is performed automatically ensuring that at any given point in time all the LPD devices run on the same version of the firmware.

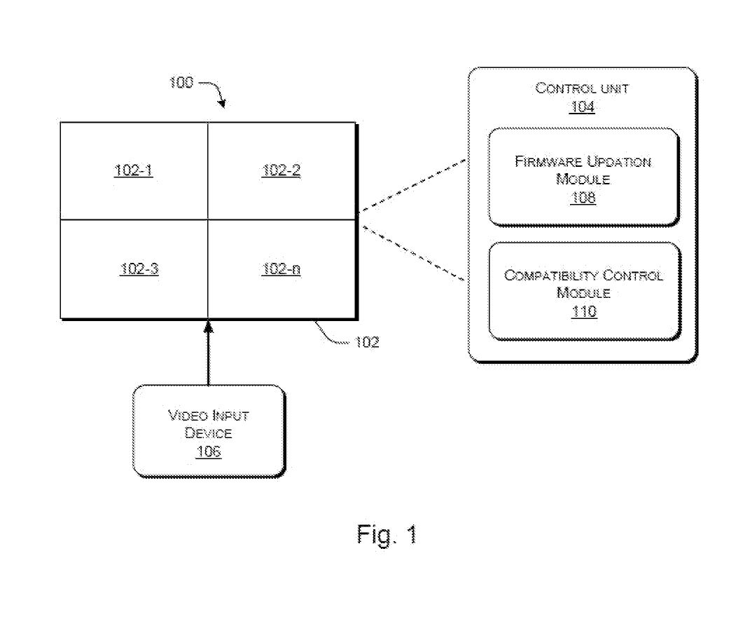

The manner in which the process for updation of the firmware in the LPD devices and other components of the LPD system is implemented shall be explained in details with respect to the FIGS. 1-4. While aspects of the described systems and methods can be implemented in any number of different devices, systems, environments, and/or configurations, the embodiments are described in the context of the following exemplary system architecture(s). Furthermore, all examples recited herein are principally intended only to aid the reader in understanding the principles of the present subject matter and the concepts contributed by the inventor(s) to furthering the art, and are to be construed as being without limitation to such specifically recited examples and conditions.

Further, even though the concepts related to the updation of firmware in electronic devices are herein explained in context of LPD systems, it will be appreciated by one skilled in the art that the concept explained in context thereto may be extended to other systems, apparatus and devices which include a plurality of peer devices coupled to a controller, without deviating from the scope and spirit of the present subject matter. For example, the updation of a plurality of discrete, replaceable units based on an update in any one of those units, described herein, may be implemented in computing systems or communication systems that have a configuration wherein a plurality of peers may be connected to a control unit. For example, the updation process may also be implemented in computing devices including, but are not limited to, desktop computers, laptops or other portable computers, communication devices, such as hand-held devices, mobile phones, and landline phones, and entertainment devices including, but are not limited to, media players. In another example, the method and system of firmware updation described herein may be implemented in display devices, such as LED based display devices.

It would be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

FIG. 1 illustrates an exemplary system comprising a plurality of devices, in accordance with an embodiment of the present subject matter. In accordance with the embodiment depicted in the figure, the system is a display system, such as a LPD system 100.

The LPD system 100 may be implemented to project images or videos. For example, the LPD system 100 may be implemented as a display panel for displaying a video that may be a commercial advertisement. In one implementation, the LPD system 100 includes one or more LPD tiles 102-1, 102-2 . . . 102-n, collectively referred to as LPD tiles 102, arranged in rows and columns. The number of LPD tiles 102 arranged in rows and columns depends on the size of the display panel of the LPD system 100 and may vary according to requirements. In other implementations the LPD tiles 102 may be placed in various arrangements to form display panels of different shapes. For example, the LPD tiles 102 may be arranged in a circular manner to form a ring shaped display panel.

Each of the LPD tiles 102 is a device capable of working individually as a stand alone device or in conjunction with numerous other similar devices. For example, in a LPD system 100 comprising four LPD tiles 102, the LPD tiles 102 may be integrated to form an integrated large display panel and may work concurrently to display parts of a video, such that a viewer sees a coherent video on the integrated display panel. Alternatively, each of the LPD tiles 102 may work as an individual display screen such that four different videos may be viewed on the display panel. All the LPD tiles 102 in the LPD system 100 can be configured to communicate with each other. Hence, each of the LPD tiles 102 is a peer to another.

As would be known to a person skilled in the art, the LPD tiles 102 may include a phosphor panel (not shown in figures) which can be excited by an array of laser beams projected onto the phosphor panel to produce images or frames of a video. The array of laser beams can be generated by a laser engine (not shown in figures) associated with the LPD tiles 102. The laser engine can be controlled by a control unit 104 present within the LPD system 100 to modulate the array of laser beam in accordance with the image that is to be produced. For the LPD system 100 to display images, video inputs are provided to the control unit 104.

In one embodiment, the video inputs may be provided by a video input device 106 coupled to the LPD system 100. It would be appreciated by a person skilled in the art that the video input device 106 can either be external or internal to the LPD system 100. A video input device 106 external to the LPD system 100 can be a video player, such as a digital video disc (DVD) player or a blueray disc (BD) player, a personal computer (PC), a laptop, and the like, capable of providing video inputs. In one embodiment, the video input device 106 may store the video input in a local memory. In another example, the video input device 106 may be connected to a communication network, such as the Internet or a local area network (LAN), to receive the video input for the LPD system 100 from a content server (not shown in figure). The content server may be a remote application server on which the video content to be displayed by the LPD system 100 may be uploaded.

In one implementation, the video content can be received through a communication network to obtain the video inputs. The communication network may be a wireless or a wired network, or a combination thereof. The communication network can be a collection of individual networks, interconnected with each other and functioning as a single large network (e.g., the internet or an intranet). Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), and Integrated Services Digital Network (ISDN). Depending on the technology, the communication network includes various network entities, such as gateways, and routers; however, such details have been omitted for ease of understanding. Additionally, descriptions and details of well-known components are omitted for simplicity of the description.

To display images in accordance with the video input received, the control unit 104 and the LPD tiles 102 are configured to function in a predefined manner. The functionality of the control unit 104 and the LPD tiles 102 is enabled by controller firmware and tile firmware contained in the control unit 104 and the LPD tiles 102, respectively. As aforementioned, the LPD tiles 102 are peer devices since they execute similar functionalities. It will be understood that the peer devices may contain the identical or similar firmware to enable them to operate in the same manner.

It will be appreciated that the term ‘firmware’ used herein refers to tile firmware as well as controller firmware either collectively or otherwise as the context may be. Further it includes firmware applications, software, software programs, one or more set of codes of computer program and, other executable instructions. The firmware update may include parts of software that may contain protocol updates, updates in configuration files or libraries and the like, that may effect a change in the firmware of the LPD devices 102, the control unit 104 or any other similar associated component of the LPD system 100.

As indicated previously, at any given instance, it is desired that all the LPD tiles 102 associated with the control unit 104 execute the same version of the firmware. This is because dissimilar versions of firmware in the LPD tiles 102 prevent the control unit 104 from communicating with the LPD tiles 102. To ensure that the LPD tiles 102 contain the same version of firmware at any given point in time, the control unit 104 comprises a firmware updation module 108.

In one implementation, the firmware updation module 108 is configured to obtain a firmware update from any one of the LPD tiles 102 and update all the other peers, i.e., the other LPD tiles 102 associated with the control unit 104, based on the firmware update. Firmware update refers to the latest version of the firmware of the LPD tiles 102. As known in the art, firmware of various electronic devices undergo revision on a regular basis to incorporate more functionalities and features in the devices. The term ‘firmware update’ may include an updated version of firmware or updates to a current firmware being executed by the LPD tiles 102 or a combination thereof. Similarly, ‘current firmware’ refers to a version of firmware presently being executed by the LPD devices 102. In the description, ‘current firmware’ has also been referred to as ‘current version of firmware’. The updates to the current firmware also append the additional functionalities and features in the firmware update to the current firmware. In addition, the firmware update may include an updated version of tile firmware as well as an updated version of controller firmware and accordingly the LPD devices 102, the control units 104 or both may undergo updation.

In one example, the firmware update may be provided to any one of the LPD tiles 102, such as LPD tile 102-1, which was restored to its operational state either through repair or through replacement. It will be gathered that the restored LPD tile 102-1 will include the updated firmware. It will also be evident that the restoration to the operational state of the LPD tile 102-1 may also be performed to update the LPD system 100, for example, to provide additional functionalities to the system LPD system 100, and not solely for the purposes of repairing or replacing a malfunctioning LPD tile. Accordingly, a restored LPD tile 102 may be any peer device, out of a plurality of peer devices in the LPD system 100, which is provided with firmware updates.

For instance, consider the previous example of the LPD system 100 with four LPD tiles 102. In a situation where one of the LPD tiles 102 is rendered non-functional, the non-functional LPD tile 102 may be replaced by a restored LPD tile 102, say the restored LPD tile 102-1. The restored LPD tile 102-1 may be provided with the firmware update in one implementation. As explained above, the firmware updation module 108 obtains the updated version of firmware from the restored LPD tile 102-1 and modifies the current version of firmware in the other three LPD tiles 102 in accordance with the updated version of firmware. The modification may include replacing the current version of firmware in the other three LPD tiles 102 with the updated version. Alternatively, the firmware updation module 108 may compare the current version of firmware with the updated version of firmware to identify specific portions of the current version of firmware that need modification. Once such portions are identified, the firmware updation module 108 overwrites the identified portions with corresponding parts of the updated version of firmware. Further, the modification may include changes in the controller firmware along with the above mentioned changes in the tile firmware.

The updation of firmware in all the LPD tiles 102 based on an updated version of firmware in the restored LPD tile 102-1 ensures that different LPD tiles 102 in the LPD system 100 operate on the same version of firmware. Further, the updation of the current version of firmware in all the peers of the new LPD device 102 is automatic and is effortless since it requires no human intervention.

There is sometimes also a possibility that the updated version of firmware in the restored LPD tile 102-1 is incompatible with the current version of firmware in the other LPD tiles of the LPD system 100. For example, the restored LPD tile 102-1 may include an additional hardware component that is enabled by the updated version of firmware. If this additional hardware component is not present in the other LPD tiles 102 of the LPD system 100, the updated version of firmware may not be supported by the other LPD tiles 102. This may result in peer devices with dissimilar versions of firmware in the LPD system 100.

Thus, in one implementation, the control unit 104 comprises a compatibility control module 110 to enable the firmware updation module 108 to maintain only compatible versions of the firmware in all the peer devices. The compatibility control module 110 is configured to determine compatibility of the firmware update with the current firmware of the peer devices.

In one implementation, the firmware update includes a firmware version identifier and a compatibility string. The firmware version identifier indicates the component to which the firmware update pertains, along with the firmware version number of the firmware update. For example, firmware version identifier indicates whether the firmware update is for the tile firmware or the controller firmware.

In one implementation, the compatibility control module 110 based on the firmware version number, may determine whether any further updation of the other peer devices needs to be performed. For example, if the firmware version number of the firmware update is the same as the firmware version number of the current firmware of the peer devices, such as LPD tiles 102, no updation would be required. However, if the firmware version numbers do not match, then the compatibility control module 110 updates the current firmware to the updated firmware corresponding to latest version.

The compatibility string is indicative of hardware components with which the firmware update is compatible. The specifications relating to the hardware components of the other peers, i.e. the other LPD tiles 102, associated with the control unit 104 that are to be updated is known to the compatibility control module 110 and is used to determine whether or not the hardware components of the other peers are compatible with the firmware update. Accordingly, in one example, when a firmware update is received by any one of the LPD tiles 102, the compatibility control module 110 analyses the compatibility string to ensure that the firmware update is a compatible version before proceeding to update the other peers.

If the firmware update and the current firmware are compatible with each other, the compatibility control module 110 modifies the current firmware in accordance with the firmware update. In other words, the current firmware may be said to be updated since the current firmware is revised with an up-to-date or a latest version of the firmware. However, if the firmware update is not compatible with the current firmware, the compatibility control module 110 notifies the incompatibility to the firmware updation module 108. The firmware updation module 108 in turn modifies the firmware update in accordance with the current firmware. This modification may be carried out in a manner similar to the modification of the current firmware in accordance with the firmware update. The modification revises the firmware update to the current firmware, ensuring that all the peer devices have the same version of the firmware. The same version of the firmware may include similar versions that are compatible version to each other. The same or compatible versions of firmware in all the LPD tiles 102 facilitate the control unit 104 in controlling the LPD tiles 102.

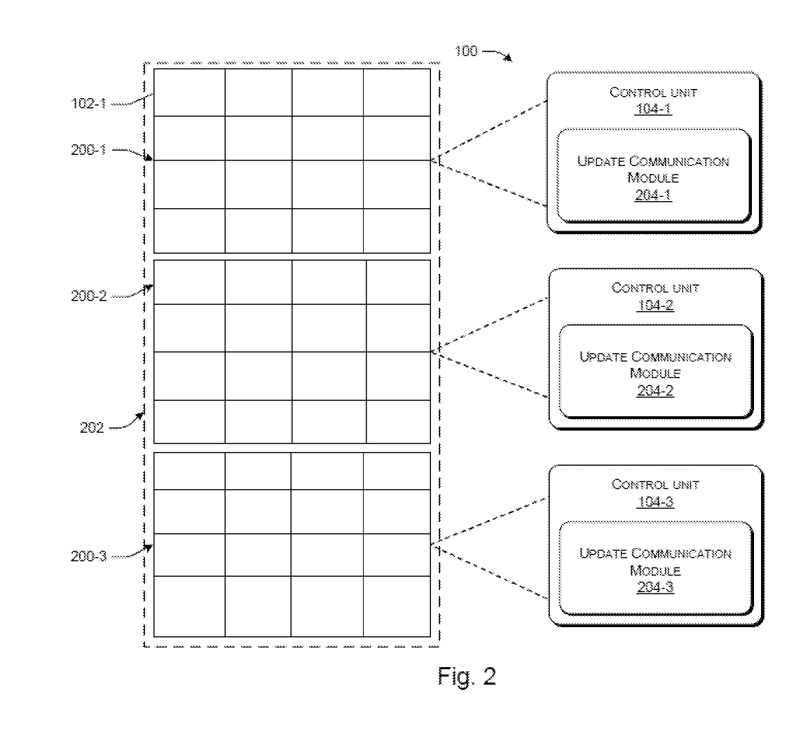

FIG. 2 shows an exemplary display system, such as the LPD system 100 comprising a plurality of control units 104, according to one embodiment of the present subject matter.

In cases where large display panels are required, a matrix of LPD tiles 102 may be arranged in rows and columns to form a large display panel. However, in some cases the number of rows and columns may not exceed beyond a certain predefined limit. The predefined limit can be dictated by the maximum number of LPD tiles 102 that the control unit 104 is configured to manage. Thus, depending on the requirement, the LPD system 100 may be implemented with more than one control unit 104, such that each control unit 104 manages a certain number of LPD tiles 102 in the LPD system 100.

In other examples, a number of LPD tiles 102 may be placed in different arrangements to form large display panels of various shapes such as a circular display panel or a ring shaped display panel, wherein LPD tiles 102 may be divided into more than one group and each group is coupled to a distinct control unit 104. Accordingly, the LPD system 100 may comprise a single control unit 104, as described in FIG. 1 or the LPD system 100 may comprise a plurality of control units 104-1, 104-2 . . . 104-n (collectively referred to as control units 104), each coupled to a group of LPD tiles 200-1, 200-2 . . . 200-n (collectively referred to as LPD tile groups 200), respectively.

In the LPD system 100 comprising multiple control units 104, the control units 104 can be considered as peers to each other. As explained earlier, the peer devices are discrete replaceable devices that may contain similar firmware and perform similar functions in the LPD system 100.

In one embodiment, each of the LPD tile groups 200 may display a video independent of each other. Accordingly, in the LPD system 100 illustrated FIG. 2, a display wall 202 may be formed by, say the LPD tile groups 200-1, 200-2 and 200-3 located at the top, middle and bottom of the display wall 202, respectively. In one embodiment, a single video or three different videos may be displayed on the display wall 202 simultaneously in the top, middle and bottom of the display wall 202. In another embodiment, the LPD tile groups 200 may work in conjunction with each other to display portions of video frames in such a manner that the image in a video frame displayed on the display wall 202 appears coherent and integrated as one image irrespective of the image being displayed by three LPD tile groups 200 in parts.

In one embodiment, the video input is provided to each of the control units 104. In another embodiment, the video input is provided to any one of the control units 104, which then communicates the video input to the other control units 104. However, in the implementation where the LPD tile groups 200 work in combination to display portions of video frames in an integrated manner, the video input provided to the control units 104 of the different tiles within the LPD tile groups 200 may be cropped. It would be appreciated by a person skilled in the art that the video input provided to the control units 104 can be cropped either previously or can be cropped by the respective control units 104.

For functions such as internal cropping of the video input, the control units 104 communicate through control signals with each other.

In one embodiment, the control signals may be received by any one of the control units 104 from a control server (not shown in Figures) and thereupon be communicated to the other control units 104. The control server may be the content server mentioned in context of FIG. 1. In one example, the control signals may include commands that enable the control units 104 to identify their location in the display panel. For instance, consider the configuration of the LPD system 100 shown in FIG. 2. The control signals may notify the control unit 104-1, 104-2 and 104-3 that they are placed at the top, middle and bottom of the display wall 202, respectively. This enables the control units 104 to crop frames of video amongst themselves and to determine the portion that needs to be displayed in the top, middle and bottom of the display wall 202.

In accordance with one embodiment of the subject matter, a firmware update present in a restored LPD tile 102, say LPD tile 102-1 in the LPD tile group 200-1, may be used to update all the other LPD tiles 102 in the LPD tile groups 200. The firmware update could include a later version of the firmware, i.e., an updated firmware or a new firmware itself. The control unit 104-1 associated with the LPD tile group 200-1 obtains the firmware update from the restored LPD tile 102-1 and provides the firmware update to the other LPD tiles 102 in the LPD tile group 200-1. In an embodiment, each of the control units 104 includes firmware updation module 108 (as shown in FIG. 1) for obtaining the firmware update. Further, the control unit 104-1 also provides the firmware update to its peers, i.e., the other control units 104-2, 104-3. Once the firmware update is received by the control units 104-2, 104-3, all the LPD tiles 102 coupled to each of them are subsequently provided with the update. In one example, where the restored LPD tile 102-1 comprises updates pertaining to the controller firmware, the control units 104 are also updated in a manner similar to the updation of the LPD tiles 102. The communication of firmware update to peer control units 104 is accomplished by update communication modules 204-1, 204-2 . . . 204-n (collectively referred to as update communication module 204), present in each of the control units 104.

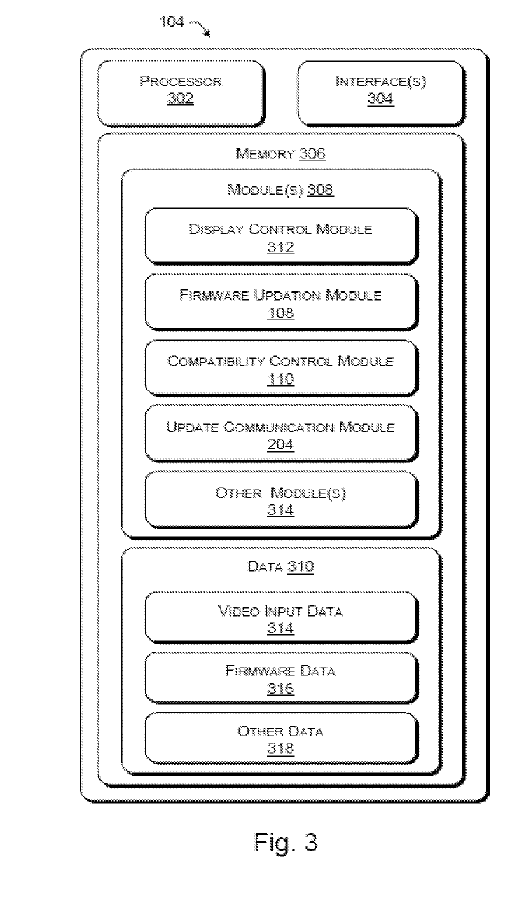

FIG. 3 illustrates an exemplary control unit 104 and the various modules therein, according to an embodiment of the present subject matter. In said embodiment, the control unit 104 includes one or more processor(s) 302, interface(s) 304, and a memory 306 coupled to the processor 302.

The processor 302 can be a single processing unit or a number of units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is configured to fetch and execute computer-readable instructions and data stored in the memory 306.

The I/O interfaces 304 may include a variety of software and hardware interfaces, for example, interface for peripheral device(s) such as input devices and, external memory components. Further, the I/O interfaces 304 may enable the control unit 104 to communicate with other computing devices, such as web servers and external databases. The I/O interfaces 304 may facilitate multiple communications within a wide variety of protocols and networks, including wired networks, e.g., LAN, cable, etc., and wireless networks, e.g., WLAN, cellular, satellite, etc. The I/O interfaces 304 may include one or more ports for connecting the control unit 104 to a number of devices, such as the remote content server and/or the control server.

The memory 306 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. The memory 306 includes module(s) 308 and data 310.

The modules 308 include routines, programs, objects, components, data structures, etc., which perform particular tasks or implement particular abstract data types. The modules 308 further include, for example, the firmware updation module 108, the compatibility control module 110, the update communication module 204 and a display control module 312. Additionally, there may be other modules 314 in the control unit 104 that include programs or coded instructions that supplement applications and functions on the control unit 104, for example, programs in the operating system.

Similarly data 310, amongst other things, serves as a repository for storing data processed, received, and generated by one or more of the module(s) 308. The data 310 includes, for example, video input data 316, firmware data 318, and other data 320. The other data 320 includes data generated as a result of the execution of one or more modules 308 in the other modules 314.

In operation, the display control module 312 of the control unit 104 manages and displays still images or videos on the LPD tiles 102 which are associated with the control unit 104. In one embodiment, the display control module 312 may obtain the display content from the video input device 106. The display content received from the video input device 106 may be stored as the video input data 316 and the LPD tiles 102 are operated to generate images or videos based on the video input data 316.

In one implementation, the firmware updation module 108 monitors the LPD tiles 102 to detect any firmware updates. For example, the firmware updation module 108 detects a firmware update when any one or more of the LPD tiles 102, say LPD tile 102-1, is restored within the LPD system 100. For the purpose, the firmware updation module 108 may query the restored LPD tile 102-1 for the firmware updates. The firmware updates may include most recent and upgraded versions of firmware. In said implementation, upon determination of an update in firmware, the firmware updation module 108 obtains the firmware update from the restored LPD tile 102. The firmware updation module 108 may copy the firmware updates from the restored LPD tile 102 and store the firmware update in the firmware data 318. In addition to the firmware updates, other details like date and time of different updates as well as details relating to the version of firmware may also be stored in the firmware data 318.

Further, the firmware update is communicated to the compatibility control module 110. The compatibility control module 110 determines compatibility of the firmware updates with the current firmware existing in the LPD tiles 102 and subsequently notifies the compatibility to the firmware updation module 108. If the compatibility control module 110 indicates that the firmware updates and the current firmware existing in the LPD tiles 102 are compatible, the firmware updation module 108 distributes the firmware updates to all associated LPD tiles 102 within the LPD tile group 200. Further, the firmware updates are provided to the update communication module 204, which then communicates the same to other peer control units 104 that may be in the LPD system 100.

However, in an event that the compatibility control module 110 indicates that the firmware updates are incompatible with the current firmware, the firmware updation module 108 discards the updated firmware. Thereupon, the firmware updation module 108 retrieves the current version of the firmware that may be stored in the firmware data 318 or from any one of the associated LPD tiles 102, and utilizes the same to overwrite the firmware updates in the restored LPD tile 102-1. This enables revision of the firmware updates in accordance with the current version of the firmware and ensures consistency in the firmware in all the LPD tiles 102.

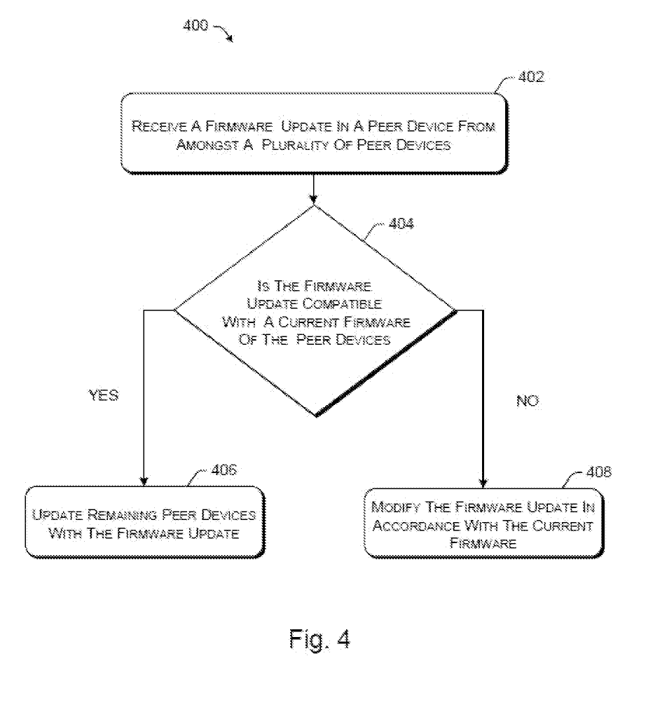

FIG. 4 illustrates an exemplary method 400 of updating firmware in electronic devices, in accordance with an embodiment of the present subject matter. The method 400 relates to updating firmware in a plurality of peer devices based on an update in any one of the peer device, according to an implementation of the present subject matter. The method 400 may be implemented in a variety of systems, apparatus and devices that comprise a plurality of discrete, replaceable units, having similar firmware, that communicate with each other through a controller. For example, the method 400, described herein, may be implemented in the above described LCD system 100 comprising a number of LCD tiles 102 controlled by one or more controlled units 104.

The exemplary method 400, completely or partially, may be described in the general context of computer executable instructions. Generally, computer executable instructions can include routines, programs, objects, components, data structures, procedures, modules, functions, etc., that perform particular functions or implement particular abstract data types. A person skilled in the art will readily recognize that steps of the method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of the described method.

The program storage devices may be, e.g., digital memories, magnetic storage media such as a magnetic disks and magnetic tapes, hard drives, or optically readable digital data storage media. The method may also be practiced in a distributed computing environment where functions are performed by remote processing devices that are linked through a communications network. In a distributed computing environment, computer executable instructions may be located in both local and remote computer storage media, including memory storage devices. Some embodiments are also intended to cover both communication network and communication devices configured to perform said steps of the exemplary method.

The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof. The method is presently provided for updating firmware in a display device. It would be appreciated that the same methods can also be implemented for updating firmware in other electronic devices without deviating from the scope of the present subject matter.

At block 402, a firmware update is received in any one of the peer devices. In one embodiment, any one LPD tile 102, say LPD tile 102-2, from amongst the plurality of LPD tiles 102 present in the LPD system 100, may receive the firmware update. As explained earlier, in one example, the updated firmware may be received by the peer device during a repair or replacement that may be performed on one of the peer device. For example, the updated firmware may be provided to one of the peer devices during the course of a periodic maintenance work that may be performed for the upkeep of the system.

The firmware update received in one of the peer devices results in two versions of firmware in the system. The peer device receiving the update may now have firmware dissimilar from the remaining peer devices of the system. To avoid an undesirable situation where the devices in the system have different versions of firmware, at block 404, the compatibility between firmware updates and the current firmware is determined. A determination to modify either the firmware update or the firmware in the remaining peer devices is based on the compatibility of the firmware update with the firmware in the remaining peer devices. The firmware in the remaining peer devices is updated in accordance with the firmware update at block 406 (‘Yes’ path from block 404), or the firmware update is modified in accordance with the firmware in the remaining peer devices at block 408 (‘No’ path from block 404).

For example, the control unit 104 within the LPD system 100 determines the compatibility of the firmware update received by the LPD tile 102-1 and the current firmware operating in the remaining LPD tiles 102. If the result of the comparison indicates that the firmware update is compatible with the current firmware (‘Yes’ path from block 404), the control unit 104 initiates an updation process to update the remaining LPD tiles 102 with the firmware update (block 406). For the purpose, in one embodiment, the control unit 104 may copy the firmware update, either entirely or required portions thereof, and provide it to the LPD tiles 102. The current firmware LPD tiles 102 is thus revised based on the firmware update. In one implementation, the control unit 104 uses a compatibility string present in the firmware update for determining the compatibility between firmware updates and the current firmware.

However, if the result of the comparison indicates that the firmware update and the current firmware are incompatible (‘No’ path from block 404), the firmware update is modified so as to make them compatible (block 408). In one example, the process of making the firmware update compatible with the current firmware includes modifying parts of the firmware update. Further, it may involve overwriting parts of the updated version of firmware with corresponding parts of the current firmware. Identification of parts of the updated version of firmware that have to be replaced with corresponding parts of the current firmware is performed by the control unit 104. Upon determination of incompatibility, revision of the firmware update to enable it to be compatible with the current firmware allows all the peer devices to have compatible versions of firmware. Accordingly, the method 400 accomplishes automatic updation of the system without deliberate efforts or dedicated human intervention to ensure that all the devices contain compatible firmware.

Although implementations for updating firmware in devices have been described in language specific to structural features and/or methods, it is to be understood that the appended claims are not necessarily limited to the specific features or methods described. Rather, the specific features and methods are disclosed as exemplary implementations for updating firmware. Many modifications, substitutions, changes, and equivalents will now occur to those skilled in the art. It is, therefore, to be understood that the appended claims are intended to cover all such modifications and changes that fall within the spirit of the claimed subject matter.

1. A method comprising:
receiving a firmware update by a restored device from amongst a plurality of devices operating a current firmware, wherein each of the plurality of devices is a peer to the restored device;
determining compatibility of the firmware update with the current firmware; and
revising one of the current firmware and the firmware update based on the determination.

2. The method as claimed in claim 1, wherein the revising comprises updating the current firmware in accordance with the firmware update.

3. The method as claimed in claim 1, wherein the revising comprises modifying the firmware update in accordance with the current firmware.

4. The method as claimed in claim 1, wherein the receiving further comprises:
detecting the firmware update in the restored device; and
providing the firmware update to a control unit communicatively coupled to each of the plurality of devices.

5. The method as claimed in claim 4, wherein the detecting further comprises:
identifying the restored device; and
querying the restored device for the firmware update.

6. A system comprising:
a plurality of devices; and
at least one firmware updation module configured to,
obtain at least one firmware update from a device from amongst the plurality of devices; and
provide the at least one firmware update to peer devices from amongst the plurality of devices.

7. The system as claimed in claim 6 further comprising a compatibility control module configured to determine compatibility of the at least one firmware update with a current firmware of the peer devices.

8. The system as claimed in claim 7, wherein the least one firmware updation module is configured to provide the at least one firmware update to the peer devices based at least in part on the compatibility determined by the compatibility control module.

9. The system as claimed in claim 6, wherein the at least one firmware updation module is configured to revise the at least one firmware update in accordance with the current firmware.

10. The system as claimed in claim 6, wherein the at least one firmware updation module is configured to monitor the device for the at least one firmware update.

11. The system as claimed in claim 6, wherein the device is a laser phosphor display device.

12. A control unit comprising:
a processor; and
a memory coupled to the processor, the memory comprising a firmware updation module configured to update at least one device based at least in part on an update in firmware of a peer of the at least one device.

13. The control unit as claimed in claim 12 further comprising a compatibility control module configured to determine compatibility of the update in firmware of the peer with a current version of firmware of the at least one device.

14. The control unit as claimed in claim 12, wherein the firmware updation module is further configured to revise the firmware of the peer in accordance with a current version of firmware of the at least one device.

15. The control unit as claimed in claim 13, wherein the compatibility control module is configured to record firmware updation data.

16. The control unit as claimed in claim 12 further comprising a firmware update communication module configured to communicate at least one update in firmware of the peer to a peer control unit.

17. The control unit as claimed in claim 12, wherein the peer of the at least one device is a restored device.

18. The control unit as claimed in claim 12, wherein the at least one device is a display device.

19. The control unit as claimed in claim 18, wherein the at least one display device is a laser phosphor display tile.
